(19) United States
(12) Patent Application Publication
(10) Pub. No.: US 2003/0071907 A1
(43) Pub. Date: Apr. 17, 2003

(54) Image taking system having a digital camera and a remote controller

(76) Inventors: Toshihiko Karasaki, Kawachinagano-Shi (JP); Noriyuki Okisu, Osakasayama-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/270,841

(22) Filed: Oct. 14, 2002

(30) Foreign Application Priority Data
Oct. 16, 2001 (JP) 2001-318080

(51) Int. Cl. H04N 5/222

(52) U.S. Cl. 348/333.01

(57) ABSTRACT

An image taking system is provided with a digital camera capable of arbitrarily designating an AF position of the subject by moving an AF cursor displayed on a liquid crystal display (LCD), and a remote controller capable of remotely operating the digital camera. On this remote controller, the position of the AF cursor displayed on the LCD of the digital camera can be changed by operating a four-button switch. Since the user can designate the AF position without touching the digital camera by operating the remote controller, position designation can be performed precisely.

This application is based on the application No. 2001-318080 filed in Japan, the contents of which are hereby incorporated by reference.

### BACKGROUND OF THE INVENTION

1. Field of the Invention

The present invention relates to a technology of an image taking system having a digital camera and a remote controller.

2. Description of the Related Art

For a conventional digital camera, a technology to designate a specific part of a subject image with a frame is disclosed in Japanese Laid-Open Patent Applications Nos. H03-187580 and H11-196301.

In the digital camera, when a specific position on the subject image is designated, image taking is frequently performed with the digital camera set on a tripod.

However, even though the digital camera is set on a tripod, since it is necessary to operate a button provided on the camera, the set frame is shifted as the button is operated. Thus, it is difficult to perform position designation precisely.

The present invention is made in view of this problem, and an object thereof is to provide a technology of an image taking system capable of precisely designating a specific position in a digital camera capable of designating a specific position on a subject.

### SUMMARY OF THE INVENTION

To solve the above-mentioned problem, an image taking system according to the present invention comprises:

a display, provided in the digital camera, for displaying an image of a subject; a first input portion, provided in the remote controller, for accepting an operation input by a user; a first designator for designating a specific position on the image displayed on the display of the digital camera in response to a predetermined operation on the first input portion; and a controller, provided in the digital camera, for performing a predetermined operation based on the specific position designated by the first designator.

According to the present invention, in a digital camera capable of designating a specific position of the subject, position designation can be performed precisely.

In the following description, like parts are designated by like reference numbers throughout the several drawings.

### BRIEF DESCRIPTION OF THE DRAWINGS

FIG. 1 is a front view of a digital camera 1 according to a first embodiment of the present invention;

FIG. 2 is a rear view of the digital camera 1;

FIG. 3 is a side view of the digital camera 1;

FIG. 4 is a bottom view of the digital camera 1;

FIG. 5 is a block diagram showing the internal structure of the digital camera 1;

FIG. 6 is a block diagram showing the structure of an image processor 200;

FIG. 7 is a view of assistance in explaining live view display;

FIG. 8 is a partial block diagram of the digital camera 1;

FIG. 9 is a view of assistance in explaining an AF cursor CR displayed on an LCD 10;

FIG. 10 is a view of assistance in explaining metering in the digital camera 1;

FIG. 11 is a view showing the data arrangement of a memory card 9;

FIG. 12 is a view showing the contents of tag information TG;

FIG. 13 is a view of assistance in explaining the structure of the relevant part of a remote controller 4;

FIG. 14 is a flowchart showing the image taking operation in an image taking system CS1;

FIG. 15 is a view of assistance in explaining a screen of the AF position designation by the camera when the remote controller is connected;

FIG. 16 is a view of assistance in explaining the structure of the relevant part of a personal computer 5 according to a second embodiment of the present invention;

FIG. 17 is a view showing function blocks of the personal computer 5;

FIG. 18 is a view showing a window WD displayed when an image taking program is executed;

FIG. 19 is a flowchart showing the image taking operation in an image taking system CS2;

FIGS. 20(a) and 20(b) are views of assistance in explaining the positional relationship between an AF cursor CRp of the personal computer 5 and an AF area AR of the digital camera 1; and

FIG. 21 is a view showing a manner of designating a rectangular trimming area TA in a modification of the present invention.

### DETAILED DESCRIPTION OF THE PREFERRED EMBODIMENTS

<<First Embodiment>>

An image taking system CS1 according to a first embodiment of the present invention comprises a digital camera 1 and a remote controller 4 capable of data transmission to the digital camera 1.

In the description given below, first, the structure of the relevant part of each of the digital camera 1 and the remote controller 4 will be described, and then, the operation of the image taking system CS1 will be described.

<Structure of the Relevant Part of the Digital Camera 1>

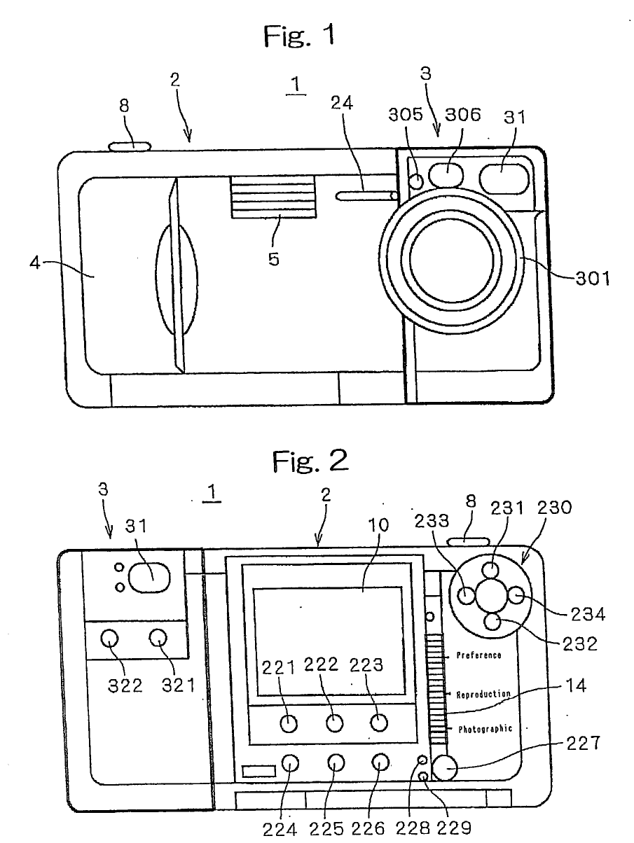

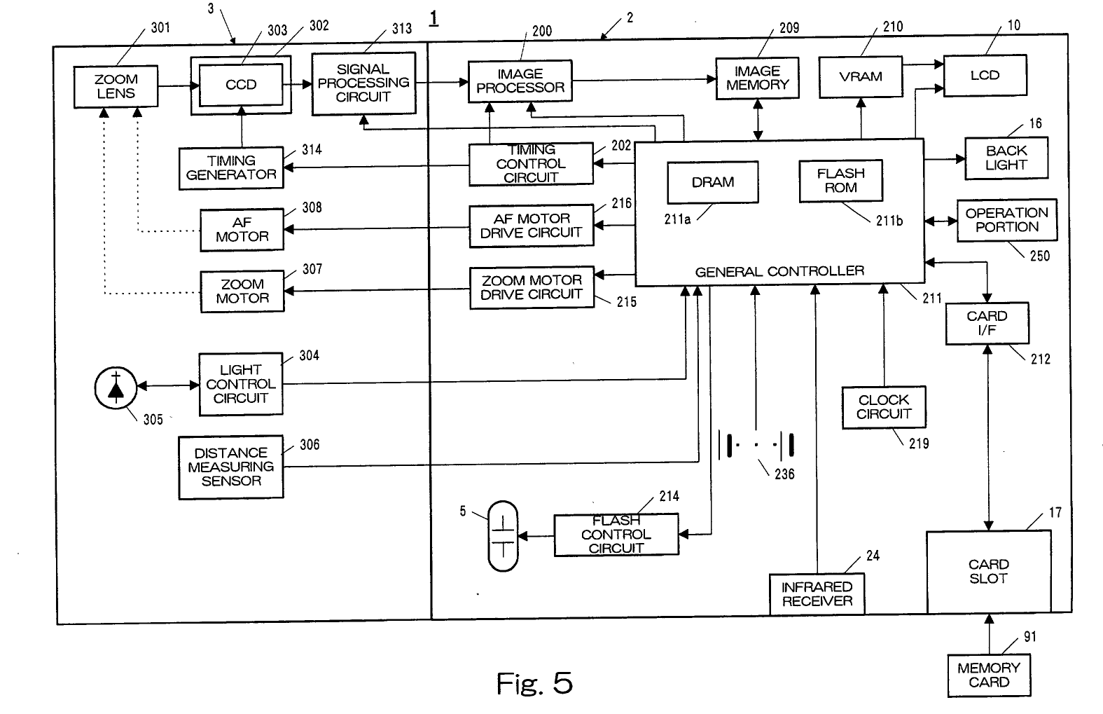

FIGS. 1 to 4 are a front view, a rear view, a side view and a bottom view of the digital camera 1, respectively. FIG. 5 is a block diagram showing the internal structure of the digital camera 1.

The digital camera 1 comprises, as shown in FIG. 1, a box-shaped camera body unit 2 and a rectangular-parallelepiped-shaped image forming unit 3 (indicated by thick lines in FIGS. 1, 2 and 4). The image forming unit 3 has a zoom lens system 301 having a macro function and serving as a taking lens. Moreover, the image forming unit 3 has a light control sensor 305 receiving the reflected flash light from the subject and an optical viewfinder 31 like lens-shutter cameras using silver halide film (hereinafter, referred to as film-based cameras). The zoom lens system 301 is capable of zooming from 35 mm to 70 mm in focal lengths of film-based cameras using 35 mm film.

In the image forming unit 3, a CCD 303 (see FIG. 5) which is a CCD color area sensor is provided behind the zoom lens system 301. The CCD 303 is a part of an image forming circuit 302.

On the front surface of the camera body unit 2, as shown in FIG. 1, a grip 4 is provided on the left end, and a built-in flash 5 and an infrared receiver 24 are provided in an upper central part. On the top surface of the camera body unit 2, a shutter button 8 is provided. The infrared receiver 24 is for receiving infrared rays that are emitted from the remote controller 4 and include signals for remotely operating the digital camera 1.

On the rear surface of the camera body unit 2, as shown in FIG. 2, an LCD 10 for providing monitor display (corresponding to a viewfinder) of taken images and playback display of recorded images is provided substantially in the center. The LCD 10 has a display screen of 400×300 pixels. Below the LCD 10, key switches 221 to 226 for operating the digital camera 1 and a power switch 227 are provided. The key switch 225 functions as an AF cursor button displaying on the LCD 10 an AF cursor CR corresponding to the in-focus position. The key switch 226 functions as a menu button. On the left of the power switch 227, an LED 228 that is on when the power is on and an LED 229 indicating that the memory card is being accessed are disposed.

Further, on the rear surface of the camera body unit 2, a mode setting switch 14 for switching among an “image taking mode”, a “reproduction mode” and a “preference mode” is provided (see FIG. 3). The image taking mode is for taking photographs. The reproduction mode is for providing on the LCD 10 playback display of taken images recorded on a memory card 9. The preference mode is for making various settings by selecting from among displayed options (setting options).

The mode setting switch 14 is a three-position slide switch. In FIG. 2, when the switch 14 is set in the lower position, the image taking mode is set, when it is set in the middle position, the reproduction mode is set, and when it is set in the upper position, the preference mode is set.

On the right side on the rear surface of the camera, a four-button switch 230 is provided. By depressing a button 231 or 232, zooming that changes the focal length of the zoom lens system 301 can be performed, and by depressing a button 233 or 234, exposure compensation can be performed manually.

On the rear surface of the image forming unit 3, as shown in FIG. 2, an LCD button 321 for turning on and off the LCD 10, and a macro button 322 are provided. Depression of the LCD button 321 changes the LCD display between on state and off state. For example, when image taking is performed with only the optical viewfinder 31, the LCD display is turned off to conserve power. When macro image taking is performed, by the macro button 322 being depressed, an AF motor 308 (see FIG. 5) is driven to bring the zoom lens system 301 into a condition where macro image taking is possible.

On the side surface of the camera body unit 2, as shown in FIG. 3, a DC input terminal 235 is provided.

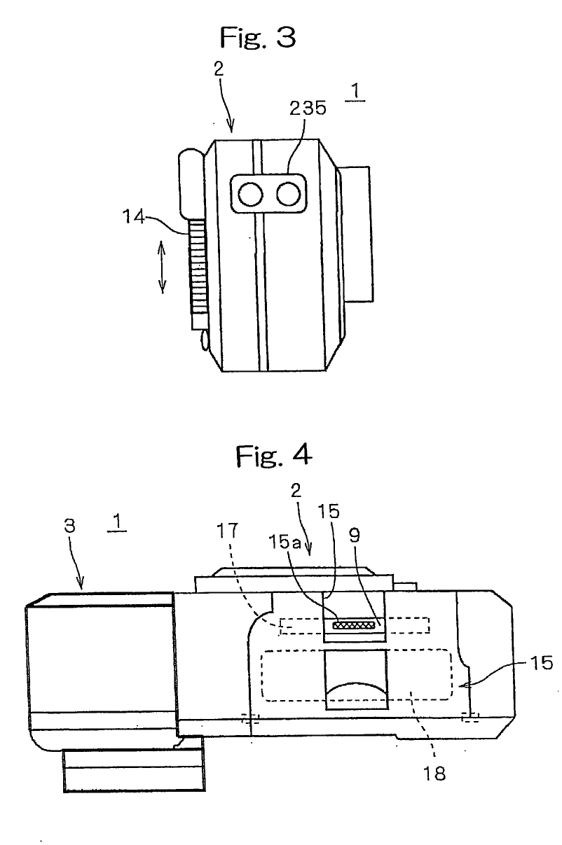

On the bottom surface of the camera body unit 2, as shown in FIG. 4, a battery cavity 18 and one card slot 17 are provided. In the card slot 17, the memory card 9 is insertable. The card slot 17 can be opened and closed by a clamshell lid 15.

In the card slot 17, an interface card is also insertable. When the lid 15 is closed with the interface card inserted, a communication connector of the interface card is exposed to the outside through an opening 15a. This enables the digital camera 1 to be connected to an external apparatus such as a personal computer with the lid 15 closed.

In the digital camera 1, four AA dry cell batteries are set in the battery cavity 18 so that a power supply battery 236 (see FIG. 5) comprising the dry cell batteries connected in series is a driving source. Moreover, electric power from an adapter which power is supplied from the DC input terminal 235 shown in FIG. 3 can be used.

Next, the internal structure of the image forming unit 3 will be described with reference to FIG. 5.

The image forming circuit 302 photoelectrically converts, by using the CCD 303, the light image of the subject formed on the CCD 303 by the zoom lens system 301, and outputs it as image data (signals comprising a string of pixel signals received at the pixels) of color components of R (red), G (green) and B (blue). Here, the CCD 303 has 1600×1200 pixels.

Since the aperture is fixed in the digital camera 1, exposure control in the image forming unit 3 is performed by adjusting the exposure amount of the CCD 303 (the charge integration time of the CCD 303 corresponding to the shutter speed). In a case where an appropriate shutter speed cannot be set when the subject brightness is low, the level of the image signal output from the CCD 303 is adjusted to thereby compensate for the inadequate exposure due to underexposure. That is, when the brightness is low, exposure control is performed by a combination of the shutter speed and gain adjustment. The adjustment of the level of the image signal is performed by an AGC (automatic gain control) circuit in a signal processing circuit 313 described later. Metering in the automatic exposure (AE) will be described later in detail.

A timing generator 314 generates a signal to control driving of the CCD 303 based on a clock transmitted from a timing control circuit 202 in the camera body unit 2. The timing generator 314 generates clock signals such as a timing signal to start and end integration (start and end exposure) and signals to control reading of light reception signals of the pixels (for example, a horizontal synchronizing signal, a vertical synchronizing signal and a transfer signal), and outputs the generated signals to the CCD 303.

The signal processing circuit 313 performs predetermined analog signal processing on the image signal (analog signal) output from the image forming circuit 302. Although not shown, the signal processing circuit 313 has therein a CDS (correlation double sampling) circuit and an AGC circuit, and reduces the noise of the image signal with the CDS circuit and adjusts the gain of the AGC circuit to thereby adjust the level of the image signal.

A light control circuit 304 controls the light emission amount of the built-in flash 5 in flash image taking, to a predetermined amount set by a general controller 211 of the camera body unit 2. In flash image taking, the reflected flash light from the subject is received by the light control sensor 305 concurrently with the start of exposure, and when the amount of reflected light received reaches the predetermined light emission amount, a light emission stop signal is output from the light control circuit 304 to a flash control circuit 214 of the camera body unit 2 through the general controller 211. The flash control circuit 214 forcefully stops the light emission of the built-in flash 5 in response to the light emission stop signal, whereby the light emission amount of the built-in flash 5 is controlled to the predetermined amount.

Moreover, the following are provided in the image forming unit 3: a zoom motor 307 for changing the zoom ratio of the zoom lens system 301 and moving the lens between a housed position and an image taking position; and an AF (automatic focusing) motor 308 for performing focusing.

Next, the internal structure of the camera body unit 2 will be described.

The general controller 211 chiefly comprises a CPU, and performs centralized control of the image taking operation of the digital camera 1 by controlling driving of the peripheral elements in the image forming unit 3 and the camera body unit 2 which elements are connected by an address bus, a data bus and a control bus.

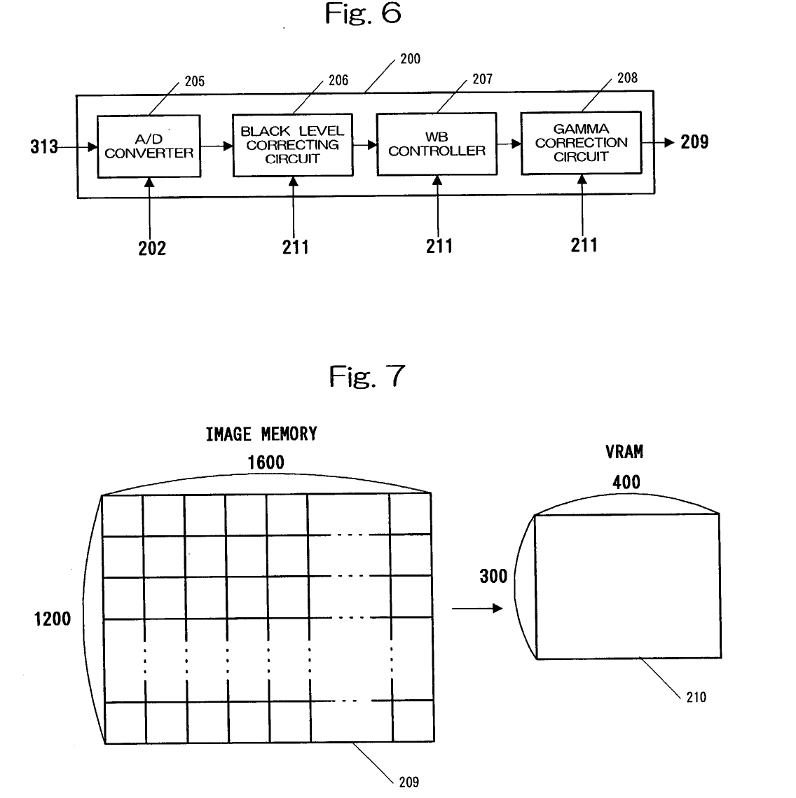

While the image data flows in FIG. 5 (and FIG. 6 described later) are also indicated by arrows between peripheral elements for convenience, in actuality, image data is sent to each peripheral element through the general controller 211. Moreover, the general controller 211 includes a work RAM 211a comprising a DRAM and a flash ROM 211b for storing programs.

Next, the image signal processing and elements associated with image display in the camera body unit 2 will be described.

The analog image signal transmitted from the signal processing circuit 313 of the image forming unit 3 undergoes various kinds of image processing at an image processor 200 in the camera body unit 2. FIG. 6 is a block diagram showing the structure of the image processor 200. First, the analog image signal transmitted to the image processor 200 is converted into a digital signal of 10 bits for each pixel by an A/D converter 205. The A/D converter 205 converts each pixel signal (analog signal) into a digital signal of 10 bits based on a clock for A/D conversion input from the timing control circuit 202.

The timing control circuit 202 generates a reference clock and clocks for the timing generator 314 and the A/D converter 205 by being controlled by the general controller 211.

A black level correcting circuit 206 corrects the black level of the A/D-converted pixel signal (hereinafter, referred to as “pixel data”) to a reference black level. A WB circuit 207 converts the level of the pixel data of each of the color components of R, G and B, and performs automatic white balance (AWB) adjustment taking the succeeding gamma correction into consideration. The white balance adjustment is performed by using a level conversion table (precisely, data thereof) input from the general controller 211 to the WB controller 207. The conversion factor (characteristic inclination) of each color component of the level conversion table is set by the general controller 211 for each taken image.

The gamma correction circuit 208 corrects the gamma characteristic of the pixel data. The output from the gamma correction circuit 208 is transmitted to an image memory 209 as shown in FIG. 5.

The image memory 209 is for storing the pixel data output from the image processor 200, and has a storage capacity for one frame. That is, when the CCD 303 has 1600×1200 pixels arranged in a matrix, the image memory 209 has a storage capacity for data of 1600×1200 pixels. Each pixel data is stored in the corresponding storage area (address).

A VRAM 210 is a buffer memory of the image data displayed on the LCD 10. The VRAM 210 has a storage capacity for image data corresponding to 400×300 pixels of the LCD 10, that is, a capacity for 400×300 pixels.

According to the above-described structure, in a standby state in the image taking mode, each of the pixel data of the images taken by the image forming unit 3 at predetermined time intervals is processed by the image processor 200, stored in the image memory 209, transferred to the VRAM 210 through the general controller 211, and displayed on the LCD 10. This enables live view (preview) display where images of the subject before image taking are displayed as a moving image on the LCD 10. The standby state is a state before the shutter button 8 is half depressed (S1ON).

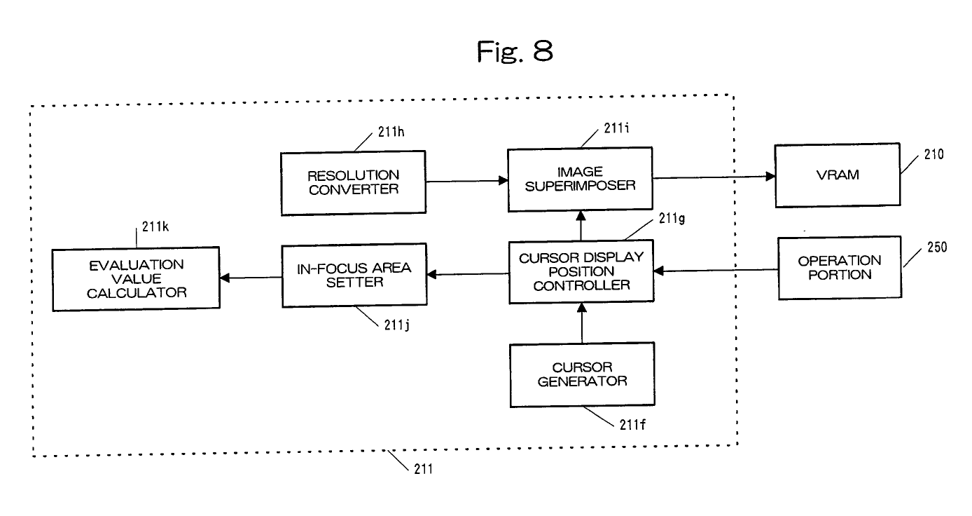

In this live view display, as shown in FIG. 7, the image data in the image memory 209 of 1600×1200 pixels is thinned out to ¼ in length and width, and transferred to the VRAM 210 of 400×300 pixels.

In the reproduction mode, the image read out from the memory card 9 undergoes predetermined signal processing by the general controller 211, is transferred to the VRAM 210, and is displayed on the LCD 10 for playback. When an image is displayed on the LCD 10, a backlight 16 is turned on by being controlled by the general controller 211.

Next, other elements in the camera body unit 2 will be described.

A card I/F 212 is an interface for transmitting and receiving signals to and from the memory card 9 inserted in the card slot 17. Specifically, the card I/F 212 writes and reads image data to and from the memory card 9. Moreover, when an interface card is inserted in the card slot 17, the card I/F 212 performs data input and output between the digital camera 1 and an external apparatus through the interface card.

The flash control circuit 214 is a circuit controlling light emission of the built-in flash 5 as mentioned above. The flash control circuit 214 controls the presence or absence, the amount and the timing of light emission of the built-in flash 5 based on a control signal of the general controller 211, and controls the amount of light emission of the built-in flash 5 based on the light emission stop signal input from the light control circuit 304.

A clock circuit 219 is for managing the date and time of image taking, and is driven by a non-illustrated different power source.

Moreover, a zoom motor driving circuit 215 and an AF motor driving circuit 216 for driving the zoom motor 307 and the AF motor 308 are provided in the camera body unit 2. These circuits function in response to operations of the shutter button 8 and an operation portion 250 comprising the above-mentioned various switches and buttons.

The shutter button 8 is a two-stroke switch where a half depressed condition (S1ON) and a fully depressed condition (S2ON) are detectable. When the shutter button 8 is half depressed in the standby state, the AF motor driving circuit 216 drives the AF motor 308 to move the zoom lens system 301 to a position where in-focus state is obtained.

When the button 231 or 232 is depressed, a signal from the button is transmitted to the general controller 211, and on an instruction from the general controller 211, the zoom motor driving circuit 215 drives the zoom motor 307 to move the zoom lens system, whereby optical zooming is performed.

The elements in the camera body unit 2 have been described. The general controller 211 performs by means of software various functions as well as data transmission and reception to and from peripheral elements and timing control.

For example, the general controller 211 has a brightness determination function and a shutter speed setting function for setting the exposure control value (shutter speed). The brightness determination function is a function of determining, in the standby state, the brightness of the subject by using an image captured by the CCD 303 every 1/30 second and stored in the image memory 209. The shutter speed setting function is a function of setting the shutter speed (the integration time of the CCD 303) based on the result of the determination of the subject brightness by the brightness determination function.

To record taken images, the general controller 211 has a filtering function, a recorded image generating function and a played back image generating function.

The filtering function is a function of correcting the image quality associated with the edge by correcting, by a digital filter, the high-frequency component of the image to be recorded.

The recorded image generating function is a function of reading out the pixel data from the image memory 209 and generating a thumbnail image and a compressed image to be recorded on the memory card 9. Specifically, by reading out pixel data from the image memory 209 every eight pixels both in the lateral and the longitudinal directions and successively transmitting the data to the memory card 9 while performing scanning in a raster scanning direction, a thumbnail image is generated and recorded onto the memory card 9. Moreover, in recording the compressed image data onto the memory card 9, all the pixel data is read out from the image memory 209, and after undergoing predetermined JPEG compression such as two-dimensional DCT or Huffman coding, the pixel data is recorded onto the memory card 9.

As a concrete operation, in the image taking mode, when an instruction to perform image taking is provided by the shutter button 8, a thumbnail image of the image captured in the image memory 209 after the provision of the image taking instruction and a compressed image by JPEG method at a set rate are generated, and these images are recorded onto the memory card 9 together with the tag information on the taken image (information such as the frame number, the exposure value, the shutter speed, the compression rate, the image taking date, data as to whether the flash is on or off at the time of image taking, scene information and the image determination result). The format of recording of the image data onto the memory card 9 will be described later in detail.

The played back image generating function is a function of generating a played back image by decompressing compressed data recorded on the memory card 9. As a concrete operation, when the mode setting switch 14 is set at the reproduction mode, the image data of the highest frame number in the memory card 9 is read out, decompressed and transferred to the VRAM 210. Consequently, the image of the highest frame number, that is, the image taken most recently is displayed on the LCD 10.

<AF>

The digital camera 1 has an image taking mode in which the AF cursor CR designating the in-focus (AF) position is displayed on the LCD 10, and this will be described in the following:

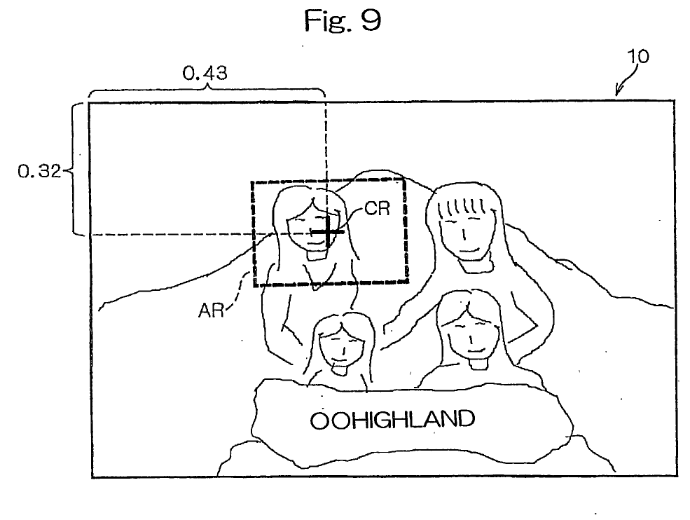

FIG. 8 is a partial block diagram of the digital camera 1.

The general controller 211 has a cursor generator 211f, a cursor display position controller 211g, a resolution converter 211h, an image superimposer 211i, an in-focus area setter 211j and an evaluation value calculator 211k.

The cursor generator 211f reads out from the flash ROM 211b the cursor data for generating the AF cursor CR shown in FIG. 9 on the LCD 10, and transfers it to the cursor display position controller 211g. The AF cursor CR is a cross shape, and has a size of 16×16 pixels on the LCD 10.

The cursor display position controller 211g changes the display position of the AF cursor CR on the LCD 10 based on the user's operation input on the operation portion 250. By this, the AF cursor CR acting as a pointer moves on the LCD 10 in response to the user's operation input. Moreover, the cursor display position controller 211g switches between display and non-display of the AF cursor CR on the LCD 10.

The resolution converter 211h generates an image by thinning out to ¼ the image data obtained by the CCD 303, and transfers the generated image to the image superimposer 211i.

The image superimposer 211i superimposes the image of the AF cursor input from the cursor display position controller 211g on the image input from the resolution converter 211h, and transfers the image to the VRAM 210. By the superimposition, the size of the AF cursor CR on the LCD 10 is fixed irrespective of the rate of thinning out by the resolution converter 211h.

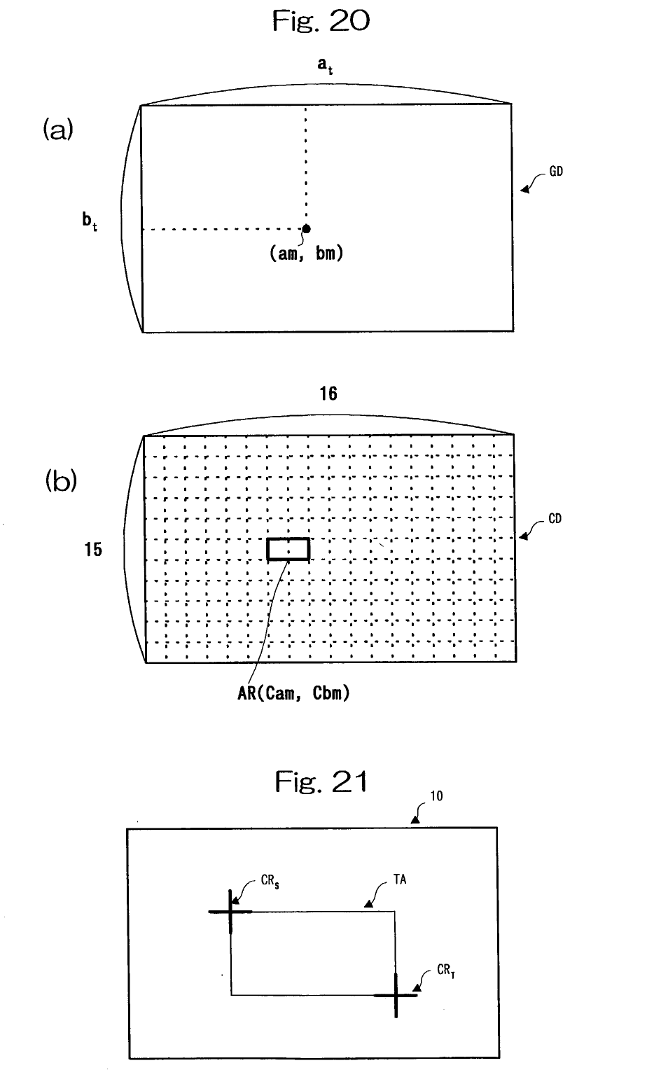

The in-focus area setter 211j sets an AF area AR (see FIG. 9) used for focusing and corresponding to the position of the AF cursor CR on the screen of the LCD 10. The AF area AR has a size of, for example, 200×80 pixels. Moreover, the AF area AR discretely moves in 16 steps of 100 pixels in the lateral direction and in 15 steps of 80 pixels in the longitudinal direction on the image obtained by the CCD 303 (see FIG. 20(b)).

The evaluation value calculator 211k performs, when the shutter button 8 is half depressed (S1ON), an evaluation value calculation for performing automatic focusing according to the contrast method. In this calculation, an evaluation value that is the sum of the absolute values of the differences between the adjoining pixels is calculated with respect to the taken image data corresponding to the AF area AR. Then, the lens is driven, and the lens position where the evaluation value is highest is regarded as the in-focus position. Thus, since focusing is performed by driving the zoom lens system 301 with respect to the AF area AR corresponding to the in-focus position, the focus can be adjusted with aim at a main subject or the like.

The digital camera 1 also has an image taking mode in which the AF position is not designated by the AF cursor CR but the AF area AR is set in a predetermined position of the LCD 10, specifically, in the center of the screen.

<AE>

AE is performed based on centerweighted metering with respect to the position of the AF cursor CR on the screen of the LCD 10. In other words, the AF cursor CR functions also as an AE cursor corresponding to the metering point.

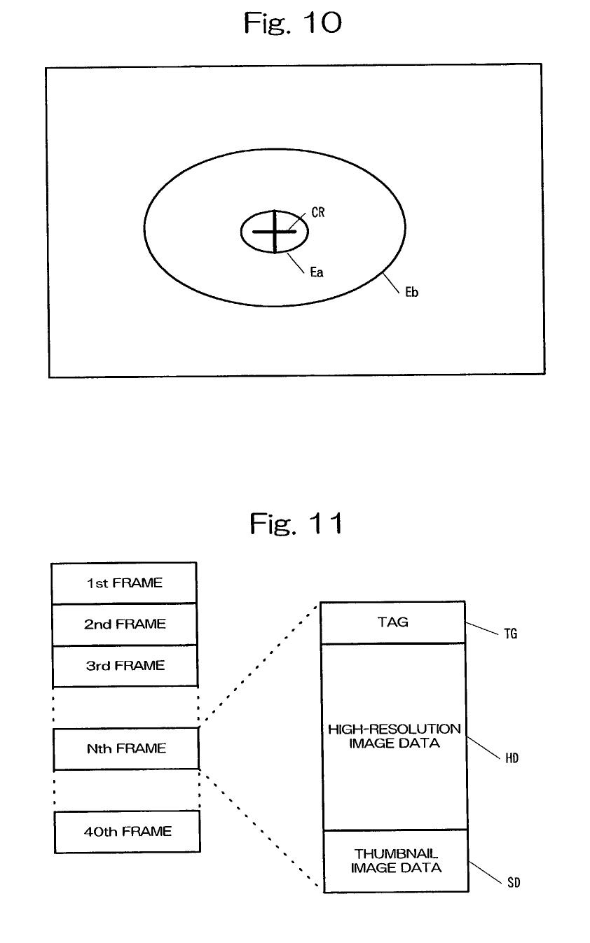

In this metering, as shown in FIG. 10, an ellipse Ea and an ellipse Eb acting as metering areas are set with the AF cursor CR as the center, and using, for example, a weighting factor 8 for the area that is inside the ellipse Ea and using, for example, a weighting factor 2 for the area that is inside the ellipse Eb but outside the ellipse Ea, a metering calculation with respect to the image data obtained by the CCD 303 is performed. This enables appropriate metering with aim at a main subject.

<Image Data Recording>

The image data obtained by the CCD 303 is recorded onto the memory card 9, and the recording format will be described in the following:

FIG. 11 is a view showing the data arrangement of the memory card 9. The memory card 9 functions as a recording medium for recording taken image data. As shown in FIG. 11, on the memory card 9, the frames of images recorded by the digital camera 1 are stored in order. In each frame, tag information TG, JPEG-compressed high-resolution image data HD (1600×1200 pixels) and thumbnail image data SD (80×60 pixels) for thumbnail display are recorded.

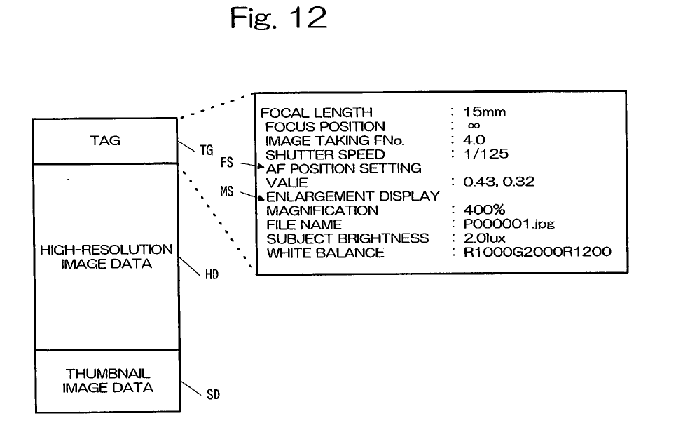

FIG. 12 is a view showing the contents of the tag information TG.

In the tag information TG, the image taking focal length and so forth are recorded, and an AF position setting value FS and an enlargement display magnification MS are recorded so as to be associated with image data.

The AF position setting value FS represents the coordinate value of the center of the AF cursor CR when the length and the width of the entire image are each 1, and is a numerical value not less than 0 and not more than 1. For example, for the position of the AF cursor CR shown in FIG. 9, 0.43 and 0.32 are set as the AF position setting value. Thus, since the AF position is recorded in the form of the ratio to the entire image, even when image taking is performed with a digital camera having a different AF cursor movement step or having a different number of display pixels or image taking pixels, the use of the information on the AF position is facilitated.

The enlargement display magnification MS is information used when the image is enlarged with respect to the AF position, and is set, for example, to 400% when the taken image is enlarged.

<Structure of the Relevant Part of the Remote Controller 4>

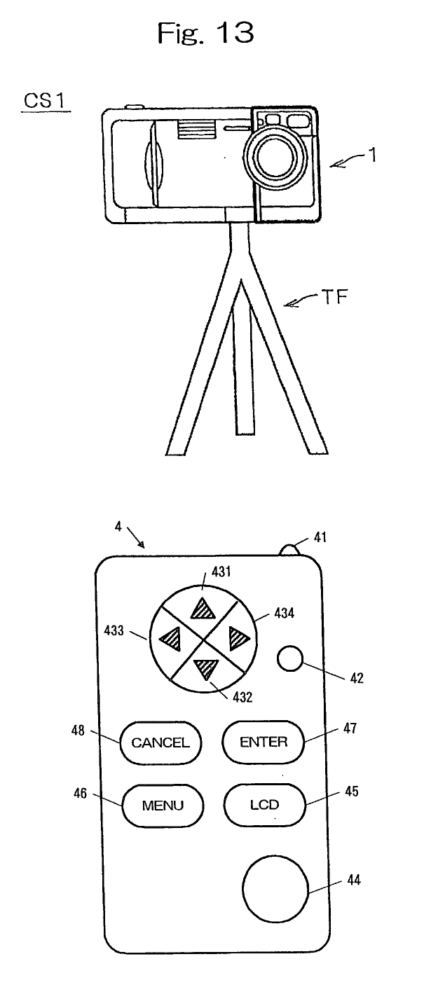

FIG. 13 is a view of assistance in explaining the structure of the relevant part of the remote controller 4.

The remote controller 4 has a rectangular plate form, and functions as a remote control device. The remote controller 4 has an infrared emitter 41 on its side surface. On the top surface of the remote controller 4, an AF cursor button 42, a four-button switch 43 and a shutter button 44 are provided. Moreover, the remote controller 4 has an LCD button 45, a menu button 46, an enter button 47 and a cancel button 48.

The infrared emitter 41 emits infrared rays including signals for remotely operating the digital camera 1 to the infrared receiver 24 of the digital camera 1.

The AF cursor button 42, the four-button switch 43 and the shutter button 44 are members for inputting instructions to the digital camera 1 like the AF cursor button 225, the four-button switch 430 and the shutter button 8. The LCD button 45 and the menu button 46 are also members for inputting instructions to the digital camera 1 like the LCD button 321 and the menu button 226.

The enter button 47 and the cancel button 48 are members operated to enter or cancel setting on the setting screen displayed on the LCD 10 of the digital camera 1 by depressing the menu button 46.

The operation of the image taking system CS1 having the digital camera 1 and the remote controller 4 structured as described above will be described in the following:

<Operation of the Image Taking System CS1>

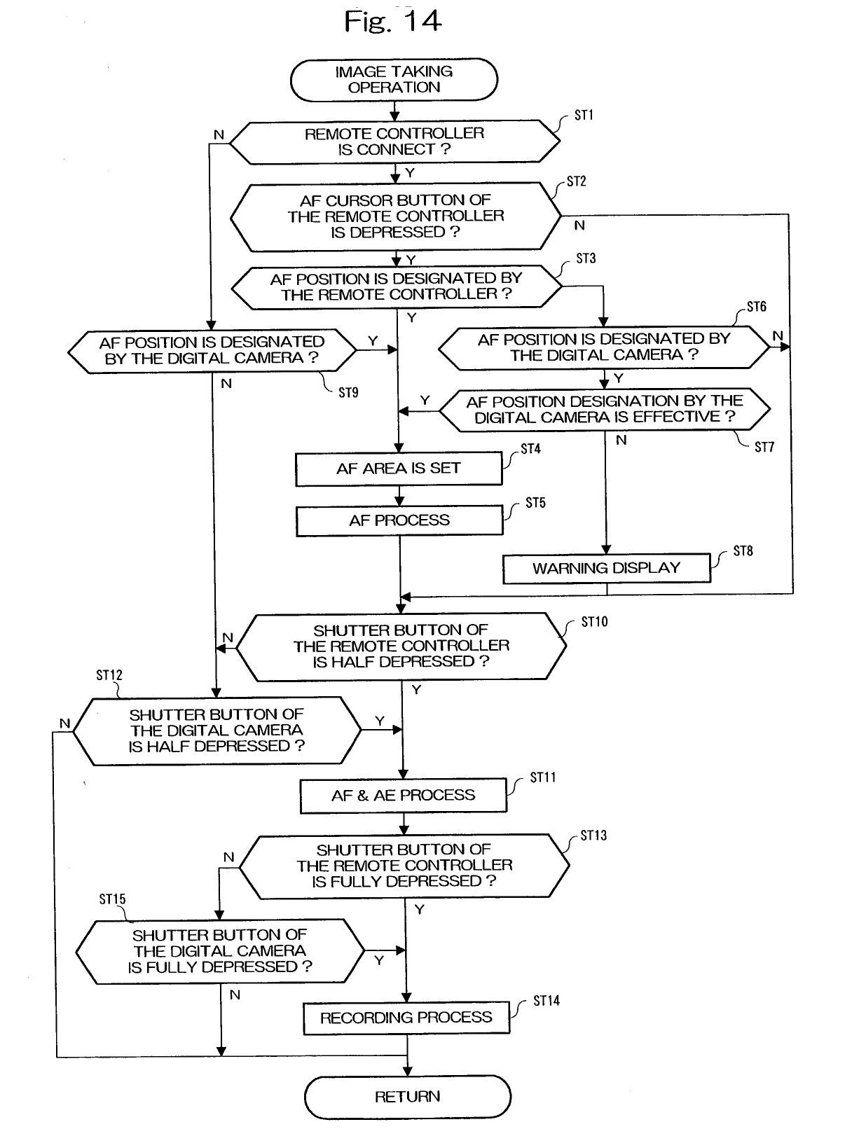

FIG. 14 is a flowchart showing the image taking operation in the image taking system CS1. This operation is performed by the general controller 211 of the digital camera 1.

At step ST1, it is determined whether the remote controller 4 is connected to the digital camera 1 or not. In the determination as to whether the remote controller 4 is connected or not with respect to data transmission, the general controller 211 transmits a signal to the remote controller 4 at predetermined time intervals, and when there is a response, it is determined that the remote controller 4 is connected and when there is no response, it is determined that the remote controller 4 is not connected. When the remote controller 4 is connected, the process proceeds to step ST2. When the remote controller 4 is not connected, the process proceeds to step ST9.

At step ST2, it is determined whether the AF cursor button 42 of the remote controller 4 is depressed by the user or not. When the AF cursor button 42 is depressed, the process proceeds to step ST3. When the AF cursor button 42 is not depressed, the process proceeds to step ST10.

At step ST3, it is determined whether the AF position is designated by the remote controller 4 or not. That is, it is determined whether or not the four-button switch 43 of the remote controller 4 is operated by the user and the AF cursor CR displayed on the LCD 10 is moved. When the AF position is designated, the process proceeds to step ST4. When the AF position is not designated, the process proceeds to step ST6.

At step ST4, the AF area AR is set with respect to the AF position designated by the operation on the remote controller 4 or on the digital camera 1.

At step ST5, automatic focusing is performed by driving the zoom lens system 303 based on the image data in the AF area AR set at step ST4, and the result is displayed on the LCD 10 as a live view image.

At step ST6, it is determined whether the AF position is designated by the digital camera 1 or not. That is, it is determined whether or not the four-button switch 230 is operated by the user and the AF cursor CR displayed on the LCD 10 is moved. When the AF position is designated, the process proceeds to step ST7. When the AF position is not designated, the process proceeds to step ST10.

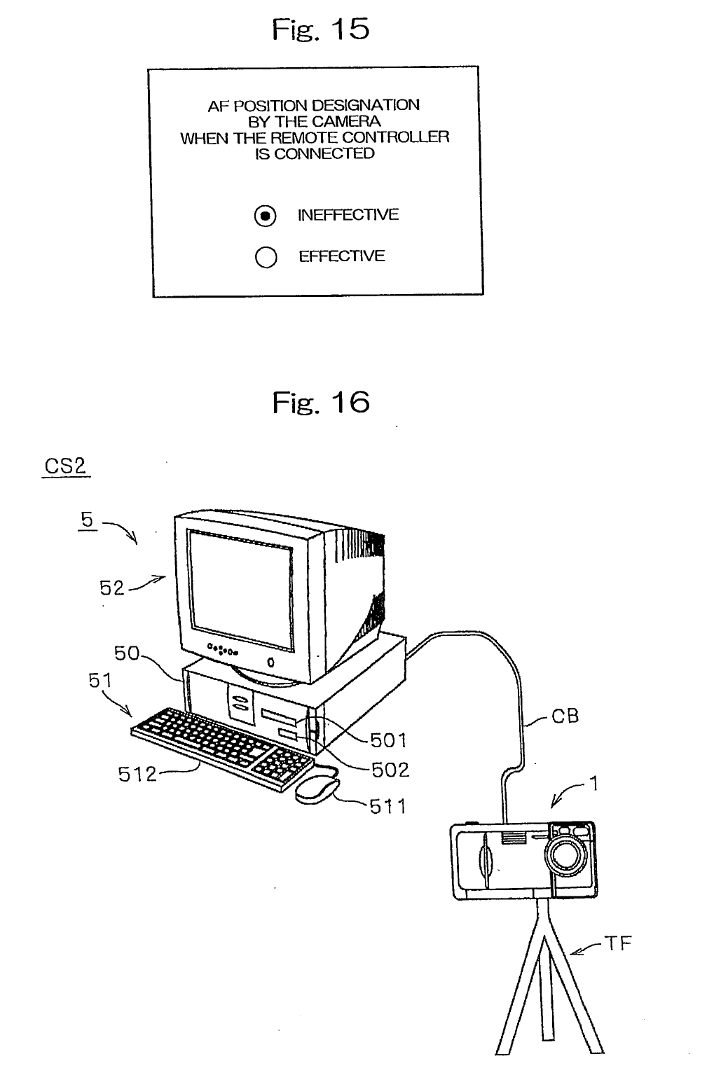

At step ST7, it is determined whether the AF position designation by the digital camera 1 is effective or not. Specifically, it is determined whether or not “effective” is selected on a screen of the “AF position designation by the camera when the remote controller is connected” displayed on the LCD 10 as shown in FIG. 15. When it is determined that “ineffective” is selected on the setting screen, in the AF position designation, only the operation on the remote controller 4 is reflected. When it is determined that “effective” is selected on the setting screen, automatic focusing is performed again at step ST5 based on the AF position changed by the operation on the digital camera 1, so that reliable processing is ensured.

When the AF position designation by the digital camera 1 is effective at step ST7, the process proceeds to step ST4. When the AF position designation is not effective, the process proceeds to step ST8.

At step ST8, warning display is provided on the LCD 10. That is, a predetermined warning is provided when the remote controller 4 is determined to be connected at step ST1 and the AF position is designated by the operation on the digital camera 1. Moreover, the designation of the AF position performed on the digital camera 1 is made ineffective. By doing this, when an inappropriate AF position designation operation is performed on the digital camera 1 although the AF position designation by the digital camera 1 is set to be ineffective, the operation can be made ineffective, and the user can be informed of this.

At step ST9, like at step ST6, it is determined whether the AF position is designated by the digital camera 1 or not. When the AF position is designated, the process proceeds to step ST4. When the AF position is not designated, the process proceeds to step ST12.

At step ST10, it is determined whether the shutter button 44 of the remote controller 4 is half depressed (S1ON) or not. When it is half depressed, the process proceeds to step ST11. When it is not half depressed, the process proceeds to step ST12.

At step ST11, in the digital camera 1, automatic focusing by driving the zoom lens system and automatic exposure by centerweighted metering are performed based on the designated position corresponding to the AF cursor CR. That is, automatic focusing which is predetermined processing is performed in response to the half depression of the shutter button 44 at step ST10. When position designation by the AF cursor CR is not performed, automatic focusing and automatic exposure are performed based on the central position of the taken image.

The result of the automatic focusing is displayed on the LCD 10 as a live view image, so that the user can easily check whether the subject is in focus or not.

At step ST12, it is determined whether the shutter button 8 of the digital camera 1 is half depressed (S1ON) or not. When it is half depressed, the process proceeds to step ST11.

At step ST13, it is determined whether the shutter button 44 of the remote controller 4 is fully depressed (S2ON) or not. When it is fully depressed, the process proceeds to step ST14. When it is not fully depressed, the process proceeds to step ST15.

At step ST14, the taken image data obtained by the CCD 303 and having undergone predetermined image processing is recorded onto the memory card 9.

At step ST15, it is determined whether the shutter button 8 of the digital camera 1 is fully depressed (S2ON) or not. When it is fully depressed, the process proceeds to step ST14.

By the above-described operation of the image taking system CS1, the user can designate the AF position without touching the digital camera by operating the remote controller, so that position designation can be performed precisely, for example, when image taking is performed with the digital camera set on a tripod TF (see FIG. 13).

<<Second Embodiment>>

An image taking system CS2 according to a second embodiment of the present invention comprises a digital camera 1 having a similar structure to that of the first embodiment, and a personal computer 5 capable of data transmission to the digital camera 1. The structure of the relevant part of the personal computer 5 will be described in the following:

<Structure of the Relevant Part of the Personal Computer 5>

FIG. 16 is a view of assistance in explaining the structure of the relevant part of the personal computer 5.

The personal computer 5 comprises a box-shaped processor unit 50, an operation unit 51 and a display unit 52, and functions as a remote control device.

The processor unit 50 has on its front surface a drive 501 into which a recording medium 6 such as an optical disk is insertable and a drive 502 into which a memory card 9 is insertable.

The operation unit 51 has a mouse 511 and a keyboard 512, and accepts input to the personal computer 5 from the user.

The display unit 52 comprises, for example, a CRT display.

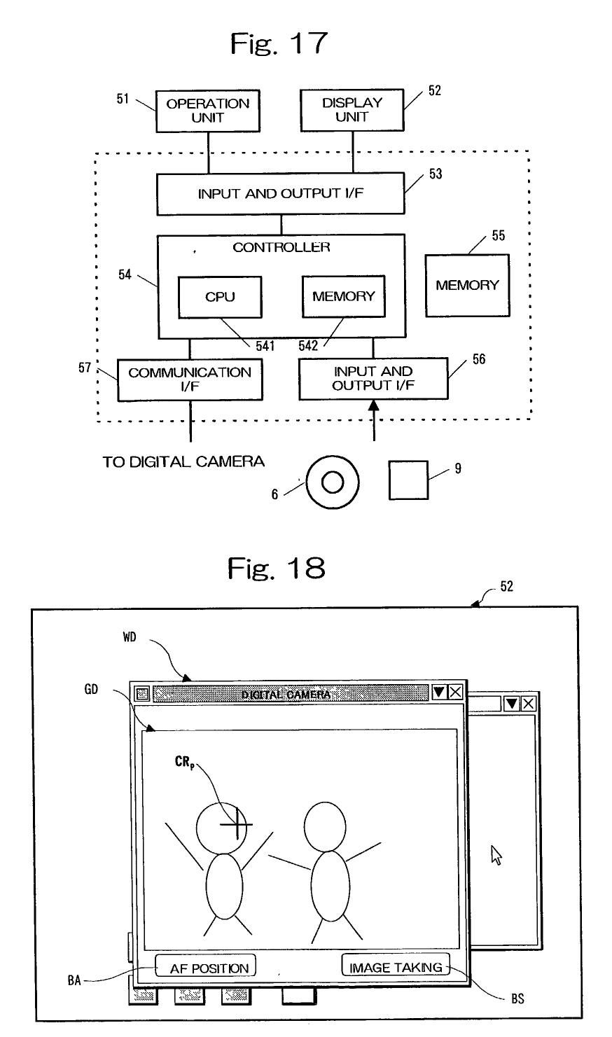

FIG. 17 is a view showing function blocks of the personal computer 5.

The processor unit 50 has an input and output I/F 53 connected to the operation unit 51 and the display unit 52, and a controller 54 electrically connected to the input and output I/F 53. Moreover, the processor unit 50 has a memory 55 electrically connected to the controller 54, an input and output I/F 56 and a communication I/F 57.

The input and output I/F 53 is an interface for controlling data transmission and reception among the operation unit 51, the display unit 52 and the controller 54.

The memory 55 comprises, for example, a hard disk, and stores an image taking program and the like.

The input and output I/F 56 is an interface for transmitting and receiving data to and from the recording media 6 and 9 through the drives 501 and 502.

The communication I/F 57 is an interface for transmitting and receiving data to and from the digital camera 1 through a cable CB. In this communication, an interface card is inserted in the card slot 17 of the digital camera 1, and the cable CB is connected to the interface card.

The controller 54 has a CPU 541 and a memory 542, and performs centralized control of the operation of the personal computer 5. By the image taking program being executed by the CPU 541 (computer), remote release can be performed while communication with the digital camera 1 is performed through the cable CB.

Into the memory 542 of the controller 54, the program data recorded on the recording medium 9 can be stored through the input and output I/F 56. With this, the image taking program stored in the recording medium 9 can be reflected in the operation of the personal computer 5.

When the image taking program is executed, a window WD shown in FIG. 18 is displayed on the display unit 52. The parts of the window WD will be described in the following:

In the window WD, an image display area GD is provided in the center, and an AF position designation button BA and an image taking button BS are provided in a lower part.

Like the LCD 10 of the digital camera 1 described in the first embodiment, a live view (preview) image taken by the CCD 303 of the digital camera 1 is displayed in the image display area GD. When the mouse 511 is clocked on the image taking button BS, the taken image is displayed in the image display area GD.

The AF position designation button BA is, like the AF cursor button 225 of the digital camera 1, for displaying an AF cursor (mouse cursor) CRp corresponding to the AF position in the image display area GD. The AF cursor CRp continuously moves by the user's operation of the mouse 511. By using the mouse 511 as described above, the AF position can be designated easily.

The image taking button BS is for remote release, that is, for providing the digital camera 1 with an instruction to perform image taking.

The operation of the image taking system CS2 structured as described above will be described in the following:

<Operation of the Image Taking System CS2>

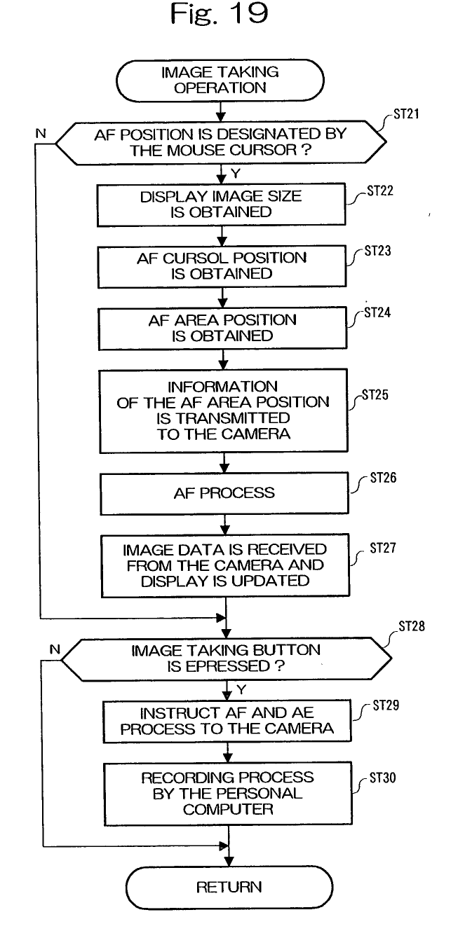

FIG. 19 is a flowchart showing the image taking operation in the image taking system CS2. This operation is performed by executing the image taking program stored in the memory 55.

At step ST21, it is determined whether the AF position is designated by the mouse cursor or not. Specifically, it is determined whether or not after the user clicks on the AF position designation button BA, the mouse 511 acting as a pointing device is operated and the AF cursor (mouse cursor) CRp is moved in the image display area GD. When the AF position is designated, the process proceeds to step ST22. When the AF position is not designated, the process proceeds to step ST28.

At step ST22, the display image size associated with the image display area GD is obtained. Specifically, information on the display pixel matrix in the image display area GD, that is, the number at of pixels in a horizontal direction and the number bt of pixels in a vertical direction shown in FIG. 20(a) are obtained.

At step ST23, the position of the AF cursor CRp is obtained. Specifically, as shown in FIG. 20(a), the pixel position (am, bm) of the AF cursor CRp with respect to the entire image display area GD is obtained.

At step ST24, the position of the AF area AR corresponding to the digital camera 1 is obtained. As described above, the AF area AR discretely moves on an image taking pixel matrix CD of the digital camera 1 in steps of a plurality of pixels, that is, in 16 steps of 100 pixels in the lateral direction and in 15 steps of 80 pixels in the longitudinal direction like the virtual lines shown in FIG. 20(b). However, since the AF cursor CRp associated with the image display area GD is continuously moved by operating the mouse 511, it is necessary to adjust the positional interrelationship. Therefore, the position (Cam, Cbm) of the AF area AR on the image taking pixel matrix CD corresponding the position (am, bm) of the AF cursor CRp is calculated.

Consequently, the AF position designated in the image display area GD having the display pixel matrix different from the image taking pixel matrix of the digital camera 1 is converted into information on the position corresponding to the image taking pixel matrix, so that appropriate position information can be provided to the digital camera 1.

At step ST25, the information on the position (Cam, Cbm) of the AF area AR obtained at step ST24 is transmitted to the digital camera 1 through the cable CB. This enables the digital camera 1 to receive position information that can be recognized easily.

At step ST26, automatic focusing is performed by driving the zoom lens system 303 of the digital camera 1 based on the information on the position of the AF area AR transmitted at step ST25.

At step ST27, the personal computer 5 receives the image data taken by the CCD 303 of the digital camera 1, and the image in the image display area GD is updated. This enables the live view image before image taking to be visually checked on the personal computer 5.

At step ST28, it is determined whether the image taking button BS on the window WD is depressed by the user's operation of the mouse 511 or not. When the image taking button BS is depressed, the process proceeds to step ST29.

At step ST29, the personal computer 5 provides the digital camera 1 with an instruction to perform automatic focusing and automatic exposure. Receiving this instruction, the digital camera 1 performs automatic focusing and automatic exposure like at step ST11 of FIG. 14.

At step ST30, the image data taken by the digital camera 1 is received by the personal computer 5 through the cable CB, and the taken image data is recorded into the memory 55 of the personal computer 5.

By the above-described operation of the image taking system CS2, the user can designate the AF position without touching the digital camera by operating the personal computer, so that position designation can be performed precisely, for example, when image taking is performed with the digital camera set on a tripod TF (see FIG. 16).

<Modifications>

(1) It is not essential to use the cursor for the designation of the AF position in the above-described embodiments, but a rectangular area may be used.

(2) It is not essential to perform the conversion to the AF area position (step ST24 of FIG. 19) in the second embodiment on the side of the personal computer; it may be performed on the side of the digital camera or by the personal computer and the digital camera in concert with each other.

(3) The present invention is applicable also when a trimming area (edit area) for image editing is designated on the LCD or on the screen of the personal computer.

FIG. 21 is a view showing a manner of designating a rectangular trimming area TA.

The trimming area TA is an area surrounded by a rectangular upper left position CRs designated by the user and a rectangular lower right position CRt designated by moving a cursor from the position CRs.

Since instructions can be remotely provided to the digital camera 1 also when the trimming area TA is designated in this manner, position designation can be performed precisely.

Moreover, when the image is enlarged with respect to the position of the cursor, the present invention is also applicable similar to the remote control associated with the AF cursor CR in the above-described embodiments. In this case, similar advantageous effects are obtained.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

What is claimed is:

1. An image taking system having a digital camera and a remote controller capable of data transmission to the digital camera, the image taking system comprising:
a display, provided in the digital camera, for displaying an image of a subject;
a first input portion, provided in the remote controller, for accepting an operation input by a user;
a first designator for designating a specific position on the image displayed on the display of the digital camera in response to a predetermined operation on the first input portion; and
a controller, provided in the digital camera, for performing a predetermined operation based on the specific position designated by the first designator.

2. The image taking system according to claim 1, wherein said predetermined operation is a focusing operation, and said display displays a result of focusing operation.

3. The image taking system according to claim 1, wherein said digital camera further comprising:
a second input portion for accepting an operation input by an user;
a second designator for designating a specific position on the image displayed on said display in response to a predetermined operation on the second input portion;
a discriminator for determining whether or not said remote controller and said digital camera are connected together with respect to data transmission.

4. The image taking system according to claim 3, wherein said digital camera further comprising:
an indicator for providing a predetermined warning when said discriminator determines that said remote controller and said digital camera are connected together, and the specific position is designated by said second designator.

5. The image taking system according to claim 3, wherein said controller makes the designation of the specific position ineffective when said discriminator determines that said remote controller and said digital camera are connected together, and the specific position is designated by said second designator.

6. The image taking system according to claim 5, wherein said digital camera further comprises a selector for making the designation of the specific position effective.

7. The image taking system according to claim 3, wherein said controller performs the predetermined operation again when said discriminator determines that said remote controller and said digital camera are connected together, and the specific position is changed by said second designator.

8. The image taking system according to claim 7, wherein said predetermined operation is a focusing operation.

9. An image taking system having a digital camera and a remote controller capable of data transmission to the digital camera, the image taking system comprising:
a display, provided in the remote controller, for displaying a preview image of a subject taken by the digital camera;
a designator, provided in the remote controller, for designating a specific position on the preview image displayed on the display; and
a controller, provided in the digital camera, for performing a predetermined operation based on the specific position designated by the designator.

10. The image taking system according to claim 9, wherein said predetermined operation is a focusing operation.

11. The image taking system according to claim 10, wherein said digital camera further comprises a selector for selecting an focusing area for performing focusing in a predetermined area, and controller associates the specific position designated by the designator with the focusing area.

12. A program product in which a program which enables a remote controller to execute a data transmission to the digital camera is recorded, the processing comprising the steps of:
displaying a image of a subject taken by the digital camera;
designating a specific position on the displayed image; and
transmitting information related to the designated specific position to the digital camera so that the digital camera performs a predetermined operation based on the information.
